(19) United States
(12) Patent Application Publication
(10) Pub. No.: US 2014/0132131 A1
(43) Pub. Date: May 15, 2014

(54) Fashion Accessory Internal Door Storage Cavity

(71) Applicant: Vicky Renee Thomas, Midland, VA (US)

(72) Inventor: Vicky Renee Thomas, Midland, VA (US)

(21) Appl. No.: 14/157,517

(22) Filed: Jan. 16, 2014

Related U.S. Application Data
(63) Continuation-in-part of application No. 13/221,946, filed on Aug. 31, 2011.

(51) Int. Cl. A47B 88/22; E05G 1/04; E05B 65/00

(52) U.S. Cl. CPC A47B 88/22; E05B 65/0075; E05G 1/04
USPC 312/204

(57) ABSTRACT

A storage device mounted within a door frame is disclosed for storage and organization of fashion accessories or similar articles is provided. The device comprises an outer door supported by the door frame, an interior door enclosing a hollow door interior for storage of articles, and at least one interior panel within the hollow door interior to separate an interior cavity therein and limit access thereto via a hidden locking mechanism. The interior panel provides separation of the internal cavity from the hollow door interior, increases surface area of the hollow door interior, and segregates a hidden interior cavity therein. The back wall of the interior cavity also provides a location for further hooks and shelving for storage. The device may be provided within the interior of a larger door, or as a door insert adapted to be incorporated into an existing door.

### CROSS REFERENCE TO RELATED APPLICATION

This application is a Continuation in Part of U.S. patent application Ser. No. 13/221,946 filed on Aug. 31, 2011, entitled “Fashion Accessory Internal Door Storage Cavity,” now pending, which claims the benefit of U.S. Provisional Application No. 61/464,451 filed on Mar. 4, 2011, entitled “The Fashion Accessory Store Door.” The patent application identified above is incorporated here by reference in its entirety to provide continuity of disclosure.

### BACKGROUND OF THE INVENTION

1. Field of the Invention

The present invention relates to closets and storage areas that may be mounted and located in disguised or hidden locations. More specifically, the present invention pertains to a storage compartment that is housed within an interior door.

Prior to this invention there have been many varieties of doors as well as various cabinet structures. One disadvantage of closets is that they are bulky and require significant floor or wall space. Many families today are choosing to live in smaller dwellings to reduce cost outlays for housing. Such families, along with other types, have a need for improved storage space that does not occupy a large portion of the household livable area.

In the past, a variety of devices have been used for the purpose of storing items within a hollow compartment. Some of these devices allow for storage of items within a hollow door. Unfortunately with these devices storage is only available in a limited space within the area. A user cannot store items in multiple compartments, which may be required for separating items by category or for each family member. These devices also do not allow the user to view and compare items before taking items outside of the storage area. Previous devices further include handles that extend outward from the door, which creates issues with space and interferences. Finally, devices in the art do not contemplate a hidden door latch that allows access to a compartment within the door, which is useful for storing items the user desires to remain hidden.

The present invention solves these problems by providing a means for multiple layers of storage within a hollow door storage system to maximize the available space. The present invention limits utilized space by providing a closet door that does not have an additional handle that protrudes outwardly towards the interior space of the room, and one that provides for hidden storage of items therein. Along with providing general storage of fashion and personal items, the present invention discloses an interior panel therein with a hidden locking means disposed therealong to control access to an interior cavity behind the interior panel, providing an optional ability to hide the presence of the interior cavity and limit access thereto to those with knowledge and means of access. Contemplated locking means therefor include a traditional magnetic push-and-release cabinet latch, a magnetically operated latch using a handheld release magnet to articulate the latch, and finally a combination or keypad secured latch that requires user input to open.

2. Description of the Prior Art

The prior art contains a variety of devices for hollow door storage systems. These devices have familiar design and structural elements for the purposes of storing and retaining various articles. The prior art for hollow door storage systems are structured by allowing only one storage space within the interior space. These devices, however, are not optimally structured to maximize the amount of storage for the space provided, nor do they provide an improved means of organizing fashion accessories or similar articles. They similarly do not provide an interior panel with a hidden locking means to limit access to a rear cavity within the storage volume, as provided by the present invention.

Similar door storage devices in the prior art include U.S. Pat. No. 6,238,030, U.S. Patent Application No. 2002/0008449, and U.S. Patent Application No. 2003/0085641 to Matselboba, which disclose a method to make a hollow door closet, and a kit to make a hollow door closet and the hollow door closet itself. The hollow door closet includes a door having a hollow interior, a volume of the hollow interior bounded at least by a backing and at least one sidewall. At least one secondary door is mounted to the door by a hinge, further providing a boundary of the volume and including an interior wall and an exterior wall. The hollow door closet has at least one hooking device that may be mounted to the backing or to the secondary door. The one or more secondary doors are provided to provide a boundary to the hollow interior. The secondary doors each have a lock and handle, the handle extending out into the interior of the room. There is space within the interior storage area along the back wall that provides storage for articles of clothing or on one of the secondary doors. The Matselboba device does not extend rearwardly from the closet door, which significantly limits the available storage space, while its door entry is a door gate that opens using two doors that spread apart to gain access to the hollow interior. The present invention provides a hollow door interior that protrudes from both sides of a standard door, improving overall storage space. It further provides a standard swinging door for access to the hollow door interior, which provides another, uninterrupted surface along the backside of the door for hanging articles or for mounting a mirror device. Finally, the present invention provides at least one interior panel that controls access to an interior cavity within the hollow door interior and behind the interior panel, which is not anticipated by Matselboba. The interior panel of the present invention contemplates a hidden access and a locking means for accessing the interior cavity therebehind.

U.S. Pat. No. 5,163,745 to Zagata describes a door closet that includes a closet box that extends rearwardly to define a compartmented chamber for containing various articles. A modification of the invention includes fiber optic illumination operative through a switch member relative to the closet box. The closet box includes at least one shoe rack, shelves and chambers for storage. This door closet provides storage space only along the back wall of the compartment chamber. The door closet and closet box both have handles that are similar to that provided in the Matselboba device, which are less than ideal given the additional space that the handles take up within the room. The Zagata devices also fails to provide efficient storage of accessories and hands-free viewing thereof and fails to anticipate an interior panel with a discreet locking means.

U.S. Pat. No. 3,822,925 to Osroff is another device in the prior art that describes a utility door storage container. The door frame has inner annular surfaces receivable of a removable storage container mountable within the annular through space of the annular frame. The storage container includes structures for removably mounting a plurality of shelves and coat hanger support. The storage container composed of a light weight fire-resistant plastic. The utility door storage container provides storage space along the back wall of the container and is removable. The storage space is located only against the back wall of the storage container, which does not maximize the space within the storage container.

Finally, U.S. Pat. No. 6,652,049 to Tyner discloses a door having storage and display areas provided therein. The door includes a back wall, side walls, and a shelf which cooperates to define storage spaces therein. The storage spaces may be enclosed by a door included therein. The main focus for this device is a way to display the items that will be placed in the storage area. There is only one section of shelves that are provided within this device. This does not focus on the ability to maximize storage space.

The devices disclosed in the prior art do not address the need for maximizing the storage space that is available through a storage space within the hollow of a door, and furthermore do not provide a means of concealing access to the interior compartment using a discreet locking means therealong. The present invention relates to a door storage device that allows a user to access articles placed in a hollow door interior via one or more swinging doors located within the interior area of the door within a door frame. The present invention provides a concealed interior cavity that is operably opened using a hidden latch, providing a means to keep hidden certain articles within the door and limit access thereto. It is submitted that the elements of the present invention substantially diverge from the prior art, and consequently it is clear that the present invention is not described by the prior art. A need exists for an improved hollow door storage system that provides storage within a condensed volume and furthermore provides a hidden cavity therein for storage of private, personal, or expensive items. In this regard the instant invention substantially fulfills these needs.

### SUMMARY OF THE INVENTION

In view of the foregoing disadvantages inherent in the known types of door closets now present in the prior art, the present invention provides a new means of storage and organization while minimizing utilized floor space to accomplish these goals.

It is therefore an object of the present invention to provide a new and improved hollow door storage system that has all of the advantages of the prior art and none of the disadvantages.

The primary object of the present invention is to provide a storage compartment mounted within the area of an existing door, wherein articles may be stored therein while reducing utilized space within a dwelling.

Another object of the present invention is to provide a secondary door access for the storage compartment within a larger door that houses the compartment and at least one hingeable interior panel.

Yet another object of the present invention is to provide a new and improved hollow door storage system that increases usable surface area for storage of many articles along the surfaces therein.

Still another object of the present invention is to provide a new and improved hollow door storage system with a mirror for viewing items as they are accessed.

Another object of the present invention is to provide a new and improved hollow door storage system that allows a user to utilize the system for the organization of fashion accessories or similar articles.

Another object of the present invention is to provide a hollow door storage system that includes at least one interior panel that employs a hidden locking mechanism to control access to a cavity behind the interior panel, allowing a user to hide certain items within the door interior and limit access thereto.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the present invention in a fully opened orientation.

FIG. 2A shows a view of the present invention with a magnetically actuated locking means disposed behind the interior panel.

FIG. 2B shows a view of the present invention with a keypad or combination locking means disposed along the interior panel.

FIG. 2C shows a view of the present invention with a discreet magnetic push and release locking means disposed along the interior panel.

FIG. 3A shows a side view of one configuration of the hollow door storage system of the present invention in which the hollow door interior extends from both sides of the outer door.

FIG. 3B shows a side view of a second configuration of the hollow door storage system of the present invention in which the hollow door interior extends from both sides of the outer door.

FIG. 4, shown is a view of a preferred embodiment of the present invention in a fully opened configuration with a variety of accessories stored therein.

### DETAILED DESCRIPTION OF THE INVENTION

Reference is made herein to the attached drawings. Like reference numerals are used throughout the drawings to depict like or similar elements of the hollow door storage system of the present invention. For the purposes of presenting a brief and clear description of the present invention, the preferred embodiment will be discussed as used for storing personal items within a door using a hollow door interior, and further providing at least one interior panel with a discreet locking means thereon for controlling access to an interior cavity therein. The figures are intended for representative purposes only and should not be considered to be limiting in any respect.

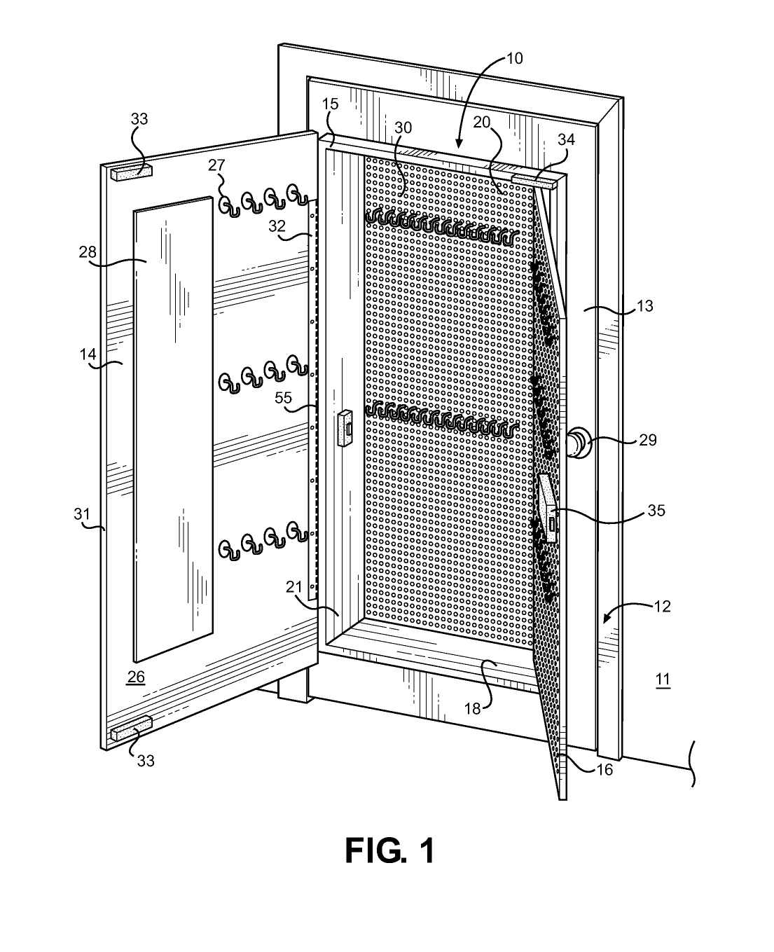

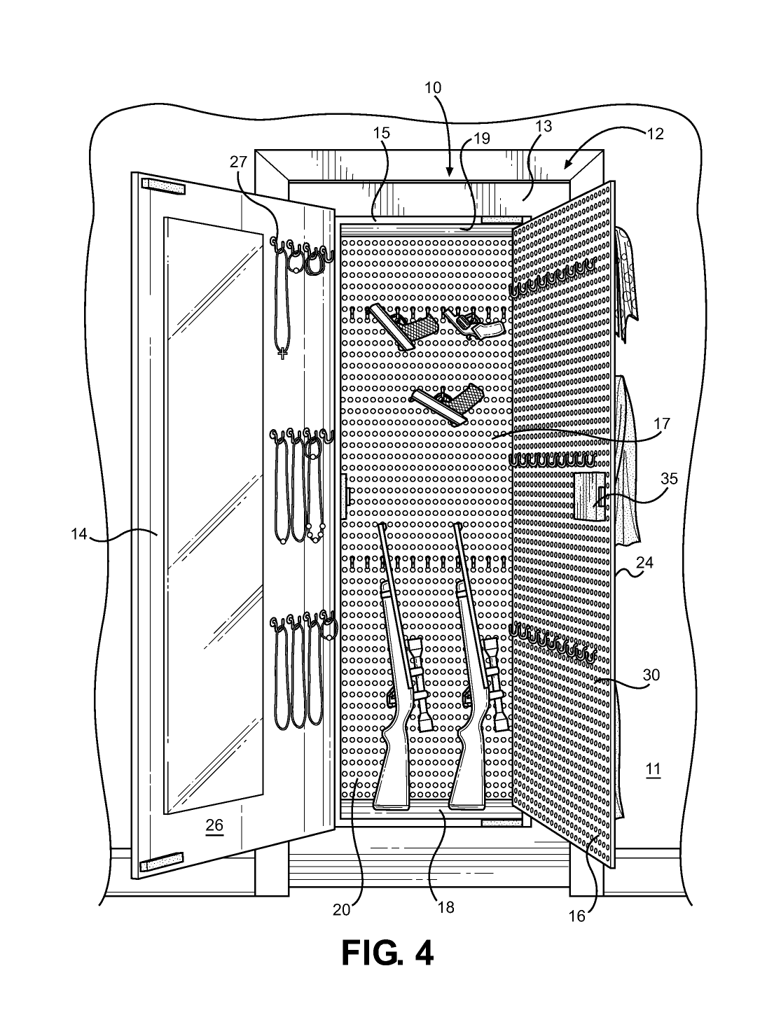

Referring now to FIGS. 1 and 4, there is shown the hollow door storage device of the present invention in a fully open position and a view of the hollow door interior 10 with a variety of accessories disposed therein. The device defines a hollow door interior 10 that is disposed within an outer door 13 surface area, which is supported by a traditional door frame 12 along a wall surface 11. This configuration provides an interior door with an internal storage compartment mounted therein. The outer door 13 is hingeably mounted to the door frame 12 to allow operation of the assembly as a normal interior door within a door frame 12. The device includes a door handle 29 mounted to the outer door 13 and oppositely disposed with respect to the outer door hinge (not shown). An interior door 14 set within the outer door 13 encloses the hollow door interior not in use. The interior door 14 is hingeably 32 mounted to an interior door frame 15 that is set within the outer door 13. The interior door frame 15 defines the outer boundary of the hollow door interior 10 within the area of the outer door 10. The interior door 14 has an outer side 25 and interior side 26, as well as an outer edge 31 and an inner edge 55, the inner edge 55 being hingedly attached to the interior door frame 15. The interior side of the interior door 26 may have peg board thereattached, along with hooks 27 for supporting accessories thereon. A mirror 28 is optionally attached to the interior side of the interior door 26 so that a user can locate an accessory and look at it in the mirror 28 before deciding which accessory to use.

The interior door 14 opens up to a hollow door interior 10 having at least one interior panel 16 disposed therein. The interior panel 16 is a hingedly attached panel (or peg board material) that is connected by a rotatable hinge along the floor 18 and ceiling 19 of the interior hollow storage compartment 17 (or optionally to the side walls 21 of the interior door frame 15). At least one of the interior panels 16 of the hollow door interior includes a discreet locking means 35, which is preferably a hidden latch or keypad access, which controls the opening of the interior panel 16. When the interior panel 16 is released and opened, a rearward interior cavity is accessible behind the interior panel 16. Several interior panels 16 may be disposed within the hollow door interior 10, however at least one includes the hidden locking means 35 that operably controls access to a rearward interior cavity for storage of personal items and items which the owner may wish to keep hidden. Along with enclosing and shrouding the interior cavity of the hollow door interior, the interior panel 16 also allows for hooks 27 and other attachments to be secured therethrough for support of accessories or other items in need of storage.

The interior frame 15 of the hollow door interior 10 includes a floor 18, a ceiling 19, a back wall 20 and two opposing side walls 21. Access to the hollow door interior 10 is controlled by the interior door 14, while the overall storage capacity is dictated by the volume within the hollow door interior 10 and the surface area therein. It is contemplated that the interior panels 16 therein include pegboard material 30, or alternatively are comprised of pegboard material 30 themselves.

In the preferred embodiment of the present invention, accessory items are placed on the hooks 27 located on the interior side 26 of the interior door 14, both sides of the interior panel 16, and on the back wall 20 of the hollow door interior 10. Small items can also be placed along the floor 18 of hollow door interior 10. Once a user is done with the selection of an accessory, the interior panel 16 can pivot back to a closed position. The interior door 14 can then be closed over the interior panel 16 and hollow door interior 10. The interior door 14 is maintained in a closed state by a magnetic attachment means 33 disposed along the interior door frame 15. A preferred means for securing the interior door 14 in place is via door magnets 33 at either end of the interior door outer edge 31 that would connect to securing magnets 34 on the interior door frame 15 of the assembly. In use, an individual can pull on a perimeter edge 31 of the interior door 14, thereby overcoming the magnetic attraction between the magnets and allowing access to the interior of the hollow door interior 10.

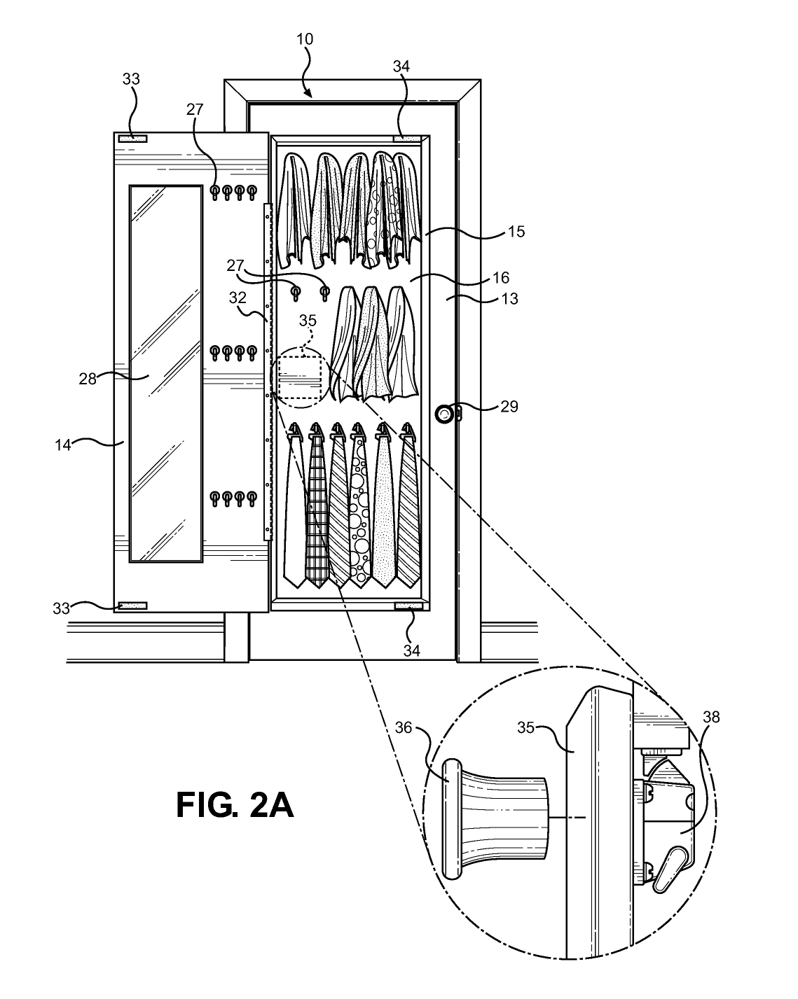

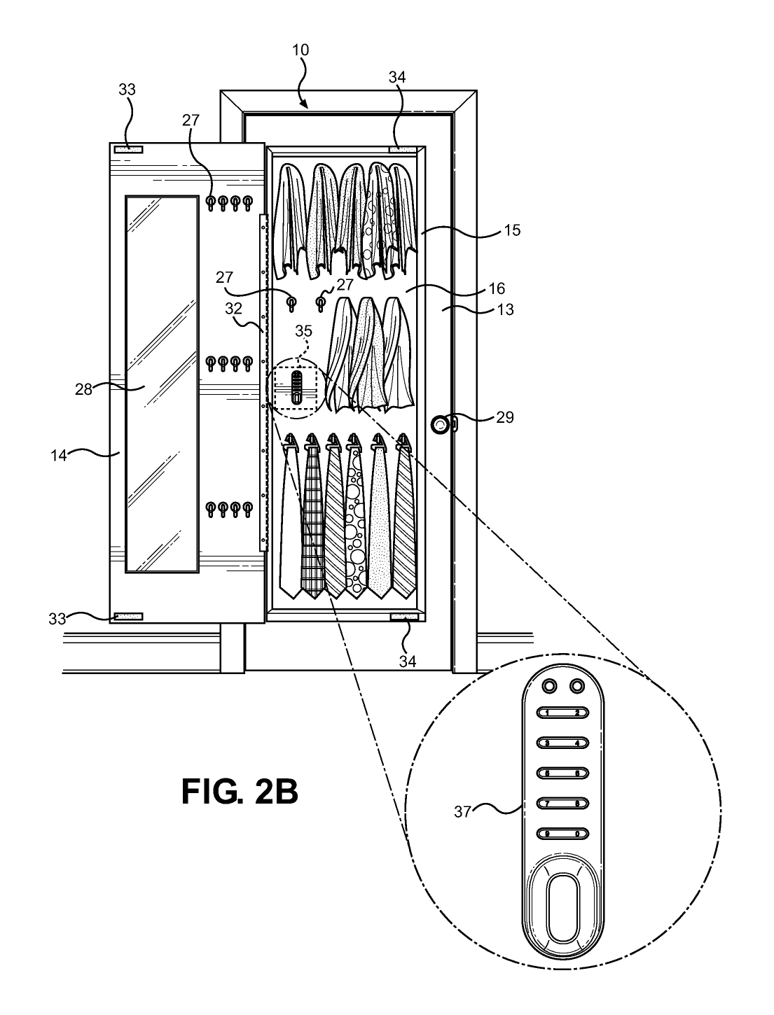

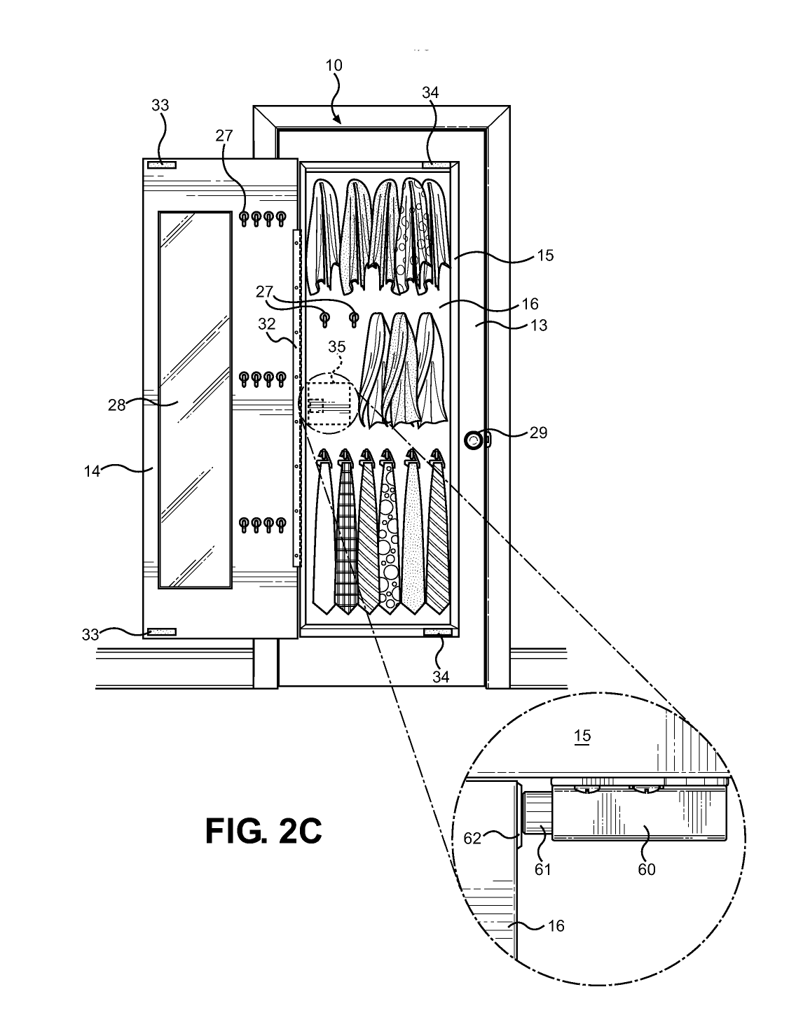

Referring now to FIGS. 2A through 2C, there are shown views of interior panel and the contemplated locking means therefor. The interior panel 16 is designed to pivot away to reveal an interior cavity that projects rearwardly therefrom. The interior panel 16 is secured in a closed position by a hidden locking means 35 that may comprise one of several alternative latch mechanisms. The first contemplated locking means 35 is a traditional magnetic push and release latch (FIG. 2C) that is adapted to securably close the interior panel 16 against the interior door frame 15 until interacted with by a user. The push and release latch of FIG. 2C comprises a magnetic latch common in the art of cabinetry, wherein the interior panel is secured via magnetic attraction of a strike plate with a magnetic latch mechanism. The user simply pushes the panel at the locking means 35 location to open or close the panel 16, whereby doing so cases a magnet at the end of a push rod within the push and lock mechanism to either release or secure the panel. A strike plate along the interior surface of the interior panel secures to the push rod of the latch mechanism. Therefore, no special key or access is required, other than knowing the mechanism exists at the location of the locking means 35. This provides a discreet means of securing the interior panel 16 and for accessing the interior cavity therebehind.

If, however, there are valuable or dangerous belongings that are housed within the panel door 16, more secure locking means may be provided. In another contemplated locking means 35 embodiment and as displayed in FIG. 2A, the locking means 35 includes an articulating latch 38 and magnetic key 36. The call-out view in FIG. 2A is an overhead view of this magnetic locking means 38, which is a mechanism known in the art (see Tot Loks, or U.S. Pat. No. 4,919,464 to Richards). This magnetically articulating latch 38 is one that articulates to an open state when a magnetic key 36 is placed in proximity to the latch 38 along the outer surface of the interior panel along the location of locking means 35. This enables opening of the interior panel 16 when a magnetic key is placed in a known location, which is discreetly disposed along the interior panel 16 to limit access or noticing the location thereof. The magnetically articulating latch 38 is positioned behind the interior panel 16, thereby being hidden from the view of individuals. In use, an individual who knows the location of the magnetic latch 38 can place the magnetic key 36 in proximity to the latch 38 positioned behind the interior panel 16. Thereafter, the latch 38 of the magnetically articulating locking latch 38 articulates into an unlatched position to enable an individual to open the panel 16, thereby allowing the individual to access the contents behind the interior panel 16. The exact design of the latch is one that may vary depending on configuration and design. It is not desired to disclose a new and novel locking design, but rather to disclose a novel implementation thereof that allows an interior cavity behind an interior panel to be operably latched and unlatched using a magnetic key 36 when placed over the hidden locking means 35.

In an alternative locking means embodiment and as displayed in FIG. 2B, the locking means 35 may include an outwardly visible coded lock 37, whereby the lock 37 includes a keypad or numbered combination that is adapted to release a latch disposed behind the interior panel 16. The latch otherwise prevents the interior panel 14 from opening. The coded lock 37 is visible along the outer surface of the interior panel, however it may be hidden from view by the hanging of accessories from hooks disposed thereover. This includes scarves and the like hanging from hooks 27 thereabove, thereby concealing the coded lock 37. this alternative locking means 35 is also located on the outer edge 24 (see FIG. 4) of the interior panel 16.

In yet another embodiment of the present invention, it is contemplated that any of the three contemplated locking means 35 may also or alternatively disposed along the interior door 14 of the assembly, thereby enabling controlled access to the hollow door interior 10 itself and before access to the interior cavity behind the interior panel 16 is desired. This controls access to all portions of the hollow door interior 10 of the present invention. If the locking means 35 is disposed on the inner door 14, it replaces the magnetic attachment means 33 with either a discrete push and release latch, a coded lock, or a magnetically articulating latch.

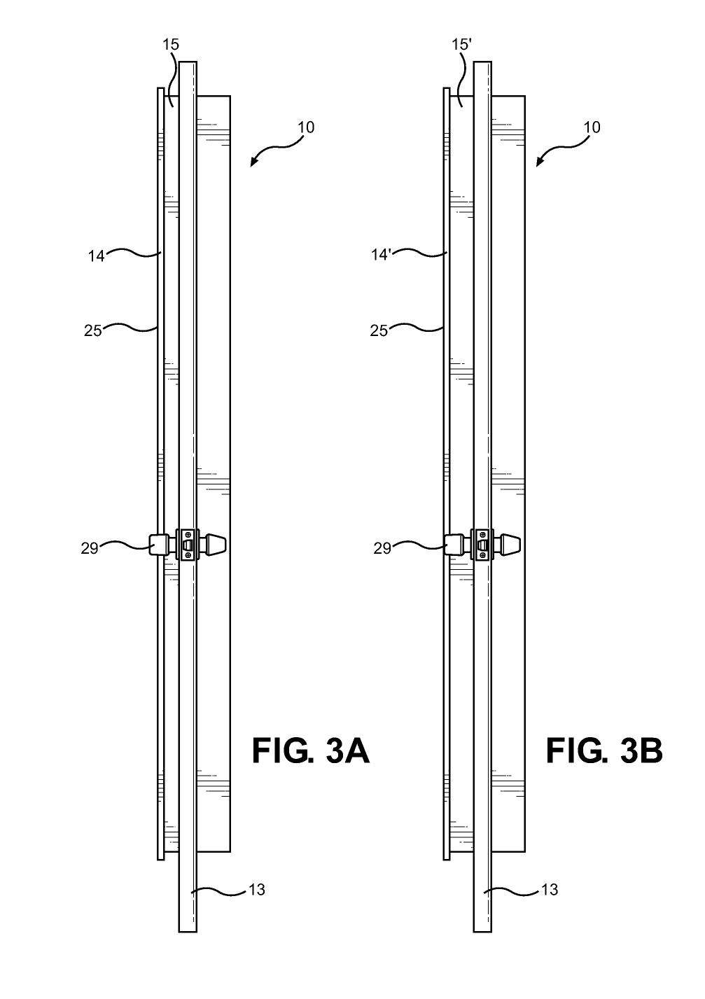

Referring now to FIGS. 3A and 3B, there is shown side views different embodiments of the hollow door interior 10 in the closed position. The rear portion of the hollow door interior 10 can be viewed from the right side of the illustrations extending outward from the outer door 13. The interior door 14 can be viewed on the left side of the drawings as it extends out from the outer door 13. The door perimeter handle 29 is mounted to an outer door 13 and is shown in the forefront of FIGS. 3A and 3B. In a preferred interior door 14 embodiment, the frame 15 of the interior door 14 does not extend outward from the outer door 13 and beyond the door perimeter handle 29, thereby ensuring that space is limited to the door area and within the space behind the door. A secondary embodiment as illustrated in FIG. 3B provides an expanded interior door 14′ that projects outward from the outer door 13, whereby the interior door frame 15′ of the hollow door interior 10 project outward to a distance that is even with the door handle 29. The primary interior door embodiment provides a smaller profile, whereas the alternative interior door embodiment provides an interior compartment that is capable of supporting larger, or more items therein.

In use, the present invention provides a means to store various articles and accessories within an internal cavity that is supported from a sectioned outer door. Access is provided to the cavity via an interior door, and an internal panel is hingeably (similar to hinge 32) attached therein to increase surface area of the cavity to provide further attachment locations for articles and accessories. The surfaces may be lined with peg board that allows any configuration of hooks or supports to be mounted thereto, or likewise sections of the surfaces may be suited to accept fasteners or other attachment means for accessory items (hooks, shelving, mirrors, etc.). The goal is to provide a user with a compact storage means for areas wherein large closets or dressers are not practical, and further to provide a hidden locking means for an interior panel to control access to the cavity therebehind. The depth of the cavity and the number of internal panels may be adjusted to suit a particular user's preferences, but it is preferred to keep the width of the cavity within the confines of the door perimeter handle to prevent oversized, bulky or cumbersome door closet cavities.

The present invention may be provided as a combined structure wherein the interior cavity is provided within a larger door, or alternatively, the device may be provided as a door insert adapted to be incorporated into an existing door and installed by a user therein. The device provides a convenient cavity that does not require excess floor space or wall space to store accessories and other items, while providing a modular design that allows the user to customize the interior setup of hooks and attachments. The interior door is a unitary structure, while the interior panel comprising of peg board material hingeably rotates outward to increase usable surface area within the cavity. The device may be manufactured as a complete door replacement, or as an insert, wherein the interior cavity is provided for placement within an existing door. It is further within the scope of the present invention to include additional storage means, such as shelving, baskets, and support rods within the interior 17 or back wall 20 of the hollow storage device of the present invention.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hollow door storage system device for hanging or storing articles, comprising:
an outer door that is hingeably attached to an outer door frame;
said outer door having a handle that is disposed on said outer door to facilitate opening of the same;
an interior door that is mounted to an interior door frame that is set into said outer door;
said interior door having an outer side, an interior side, an outer edge, and an inner edge;
said interior door enclosing a hollow door interior, said hollow door interior having an interior volume bounded by a floor, a ceiling, and a pair of side walls;
said interior door being securable in the closed position by an attachment means;
at least one interior panel hingedly attached within said interior volume of said hollow door interior, whereby said at least one interior panel pivots open from a closed position and conceals an interior cavity within said interior volume, said at least one interior panel extending between said floor, said ceiling, and said pair of side walls;
at least one interior panels comprising a locking means that is hidden from view and adapted to limit access to said interior cavity.

2) The hollow door storage system of claim 1, wherein said attachment means of said interior door comprises magnets located along said inner surface of said interior door and along said interior door frame.

3) The hollow door storage system of claim 1, wherein said locking means of said interior panel comprises a magnetically articulating latch and key combination.

4) The hollow door storage system of claim 3, wherein said magnetic latch is located behind said interior panel, whereby said magnetic latch comprises a latch that articulates into an open state and when said magnetic key is in close proximity to said latch, thereby enabling the free opening of said interior panel.

5) The hollow door storage system of claim 3, wherein said magnetic latch is discreetly positioned along said interior panel and not readily visible along an exterior surface thereof.

6) The hollow door storage system of claim 1, wherein said locking means of said interior panel comprises a coded lock.

7) The hollow door storage system of claim 6, wherein said coded lock releases a latch, thereby enabling the opening of said interior panel.

8) The hollow door storage system of claim 1, wherein said locking means of said interior panel comprises a magnetic push and release latch.

9) The hollow door storage system of claim 8, wherein said magnetic push and release latch is discreetly positioned along said interior panel and not readily visible along an exterior surface thereof.

10) The hollow door storage system of claim 1, wherein said interior panel and said interior door are adapted to support accessory items secured thereto.

11) The hollow door storage system of claim 1, wherein said interior panel comprises a pegboard material.

12) The hollow door storage system of claim 1, wherein at least one mirror is disposed within said hollow interior.

13) The hollow door storage system of claim 1, wherein said interior door frame extends outward from both sides of said outer door.
